(19) United States
(12) Patent Application Publication
(10) Pub. No.: US 2012/0151575 A1
(43) Pub. Date: Jun. 14, 2012

(54) APPARATUS AND METHOD FOR CERTIFICATING SECURITY IN PORTABLE TERMINAL

(75) Inventor: Myung-Jae JO, Gyeongsangbuk-do (KR)

(73) Assignee: SAMSUNG ELECTRONICS CO., LTD., Gyeonggi-Do (KR)

(21) Appl. No.: 13/316,823

(22) Filed: Dec. 12, 2011

(30) Foreign Application Priority Data
Dec. 13, 2010 (KR) 10-2010-0127045

(51) Int. Cl. G06F 7/04; G06F 21/00

(52) U.S. Cl. 726/19; 726/16

(57) ABSTRACT

Provided is an apparatus and method for certificating security in a portable terminal, which can enhance security in the portable terminal by multiple security certifications. An apparatus for certificating security in a portable terminal includes a security certificating unit for performing a plurality of security certification processes through a plurality of security operations performed in the portable terminal, and a control unit for performing a relevant function after completion of the security certification processes through the security operations.

### CLAIM OF PRIORITY

This application claims the benefit under 35 U.S.C. §119 of a Korean Patent Application filed in the Korean Intellectual Property Office on Dec. 13, 2010 and assigned Serial No. 10-2010-0127045, the entire disclosure of which is hereby incorporated by reference.

### BACKGROUND OF THE INVENTION

1. Field of the Invention

The present invention relates generally to an apparatus and method for certificating security in a portable terminal, and more particularly, to an apparatus and method for enhancing security in the portable terminal.

2. Description of the Related Art

A security card having a portable NFC (Near Field Communication) or RFID (Radio Frequency IDentification) unit is used to perform security certification, in order to access functions requiring encrypted server authentication, such as cloud services and Internet banking services, in a portable terminal.

However, in a security certification scheme using a security card with an NFC or RFID unit, if the security card is stolen or lost, there is a danger that the security card will be abused by an authorized person.

### SUMMARY OF THE INVENTION

An exemplary embodiment of the present invention is to provide an apparatus and method for certificating security in a portable terminal, which can enhance security in the portable terminal by multiple security certifications.

According to an aspect of the present invention, an apparatus for certificating security in a portable terminal includes: a security certificating unit for performing a plurality of security certification processes through a plurality of security operations performed in the portable terminal; and a control unit for performing a relevant function after completion of the security certification processes through the security operations.

According to another aspect of the present invention, a method for certificating security in a portable terminal includes: determining whether a plurality of operations performed in the portable terminal are identical to a plurality of security operations; and completing a plurality of security certification processes and performing a relevant function, if the operations performed in the portable terminal are identical to the security operations.

### BRIEF DESCRIPTION OF THE DRAWINGS

The above and other aspects, features and advantages of certain exemplary embodiments of the present invention will be more apparent from the following description taken in conjunction with the accompanying drawings, in which:

FIG. 1 is a block diagram of a portable terminal according to an exemplary embodiment of the present invention;

FIGS. 2A and 2B are flow diagrams illustrating a security certification process in a portable terminal according to an exemplary embodiment of the present invention; and

FIGS. 3A to 3C are diagrams illustrating a security certification process in a portable terminal according to an exemplary embodiment of the present invention.

### DETAILED DESCRIPTION OF THE INVENTION

Exemplary embodiments of the present invention will be described below in detail with reference to the accompanying drawings.

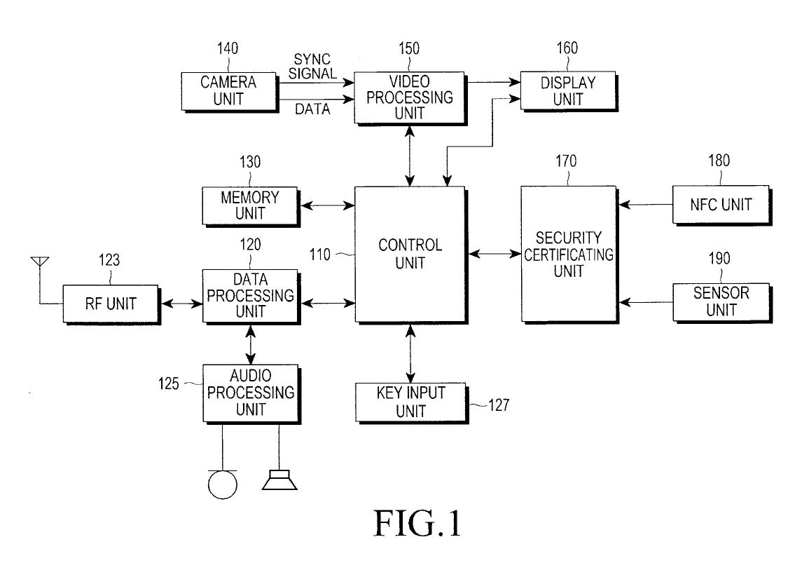

FIG. 1 is a block diagram of a portable terminal according to an exemplary embodiment of the present invention.

Referring to FIG. 1, a portable terminal according to an exemplary embodiment of the present invention includes a control unit 110, a data processing unit 120, a radio frequency (RF) unit 123, an audio processing unit 125, a key input unit 127, a memory unit 130, a camera unit 140, a video processing unit 150, a display unit 160, a security certificating unit 170, a near field communication (NFC) unit 180, and a sensor unit 190.

In operation, the RF unit 123 performs a wireless communication function of the portable terminal. The RF unit 123 includes an RF transmitter for upconverting and amplifying a transmission (TX) signal, and an RF receiver for low-noise-amplifying and downconverting a received (RX) signal. The data processing unit 120 includes a transmitter for encoding and modulating the TX signal, and a receiver for demodulating and decoding the RX signal. To this end, the data processing unit 120 may include a modem and a codec. Herein, the codec includes a data codec for processing packet data, and an audio codec for processing audio signals (e.g., voice signals). The audio processing unit 125 processes an RX audio signal outputted from the audio codec of the data processing unit 120, and transmits a TX audio signal, generated by a microphone, to the audio codec of the data processing unit 120.

The key input unit 127 includes keys for inputting numeral and character information, and function keys for setting various functions.

The memory unit 130 may include a program memory and a data memory. The program memory may store programs for controlling a general operation of the portable terminal, and programs for performing security certification through security operations.

According to an exemplary embodiment, the memory unit 130 stores information for certificating security operations. Examples of the information for certificating security operations include password information, touch pattern information, operation information, and information about the frequency and period of the contact of a security card.

The control unit 110 controls an overall operation of the portable terminal.

According to an exemplary embodiment, the control unit 110 performs a relevant function when a security certification process is completed through the security certificating unit 170.

The security certificating unit 170 performs security certification processes through security operations performed in the portable terminal.

Examples of the security operations include a security operation associated with the matching between a password of the portable terminal and a password of a security card contacting or in near communication with the portable terminal, a security operation associated with the matching of the touch pattern which is inputted with the security card in contact or in near communication with the portable terminal, a security operation associated with the matching of the portable terminal's operation which is performed with the security card in communication or in near communication with the portable terminal, and a security operation associated with the frequency and period of the contact/communication of the security card with the portable terminal. Note the frequency and the period of the contact are previously set, and then the security card sets the operation matching of the portable terminal by the security operation via the set frequency during the set period.

Further, the type and order of the security operations for the security certification processes may be selected by the user. Thus, according to an exemplary embodiment, the security certificating unit 170 performs the security certification processes while performing the security operations in a predetermined order. Also, the security certificating unit 170 performs an initial security operation if the security operation is not identical more than a predetermined number of times while the security certification processes are performed through the security operations in the predetermined order.

According to an exemplary embodiment, the NFC unit 180 performs near-field communication with an NFC unit of the security card in order to perform the security operation associated with the matching between a password of the portable terminal and a password of the security card contacting the portable terminal, among the security operations.

According to an exemplary embodiment, the sensor unit 190 detects an operation of the portable terminal in order to perform the security operation associated with the match of the portable terminal's operation which is performed with the security card in contact with the portable terminal, among the security operations.

The sensor unit 190 includes an acceleration sensor or a geomagnetic sensor.

The camera unit 140 includes a camera sensor for capturing video data and converting the video data into an electrical signal, and a signal processing unit for converting an analog video signal, captured by the camera sensor, into digital data. The camera sensor may include a CCD sensor or a CMOS sensor, and the signal processing unit may include a digital signal processor (DSP). The camera sensor and the signal processing unit may be integrated into one unit, or may be separated from each other.

A video processing unit 150 performs an image signal processing (ISP) operation to display video signals, outputted from the camera unit 140, on the display unit 160. Examples of the ISP operation include gamma correction, interpolation, spatial change, image effects, image scaling, auto white balance (AWB), auto exposure (AE), and auto focus (AF). The video processing unit 150 processes the video signals, outputted from the camera unit 140, on a frame basis, and outputs the frame video data according to the size and characteristics of the display unit 160. Also, the video processing unit 150 includes a video codec to compress the frame video data displayed on the display unit 160 and restore the compressed frame video data into the original frame video data. The video codec may include a JPEG codec, an MPEG4 codec, or a Wavelet codec. The video processing unit 150 may have an on-screen display (OSD) function to output OSD data in accordance with a display screen size under the control of the control unit 110.

The display unit 160 displays the video signal outputted from the video processing unit 150, and displays the user data outputted from the control unit 110. The display unit 160 may be implemented using an LCD. If the display unit 160 is implemented using an LCD, the display unit 160 may include an LCD, an LCD controller, and a memory for storing video data. The LCD may be a touchscreen LCD. If the LCD is a touchscreen LCD, it may also operate as an input unit. Also, the display unit 160 may display the keys of the key input unit 127.

Hereinafter, a security certification process in the portable terminal according to an exemplary embodiment of the present invention will be described below in detail with reference to FIGS. 1, 2 and 3.

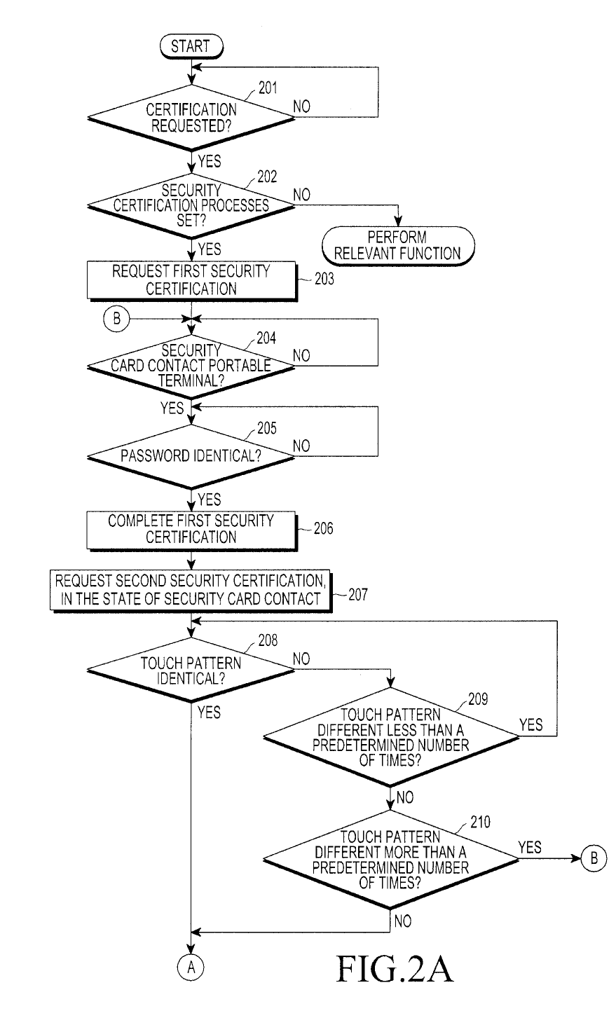

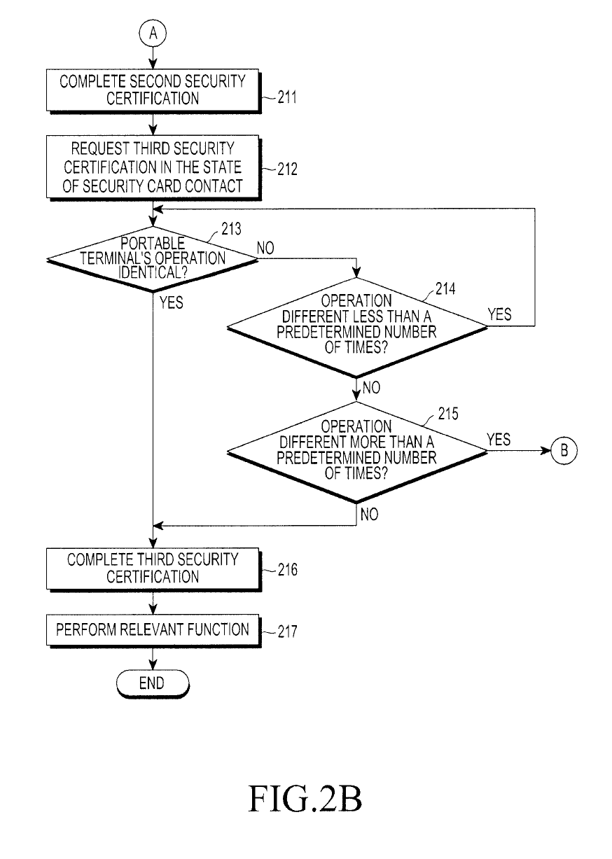

FIGS. 2A and 2B are flow diagrams illustrating a security certification process in the portable terminal according to an exemplary embodiment of the present invention.

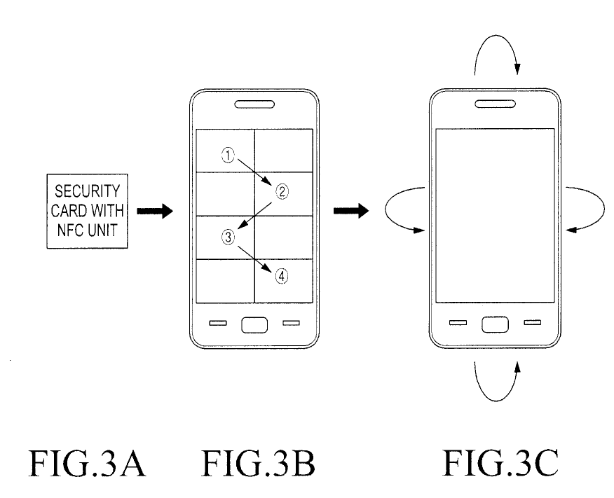

FIGS. 3A to 3C are diagrams illustrating a security certification process in the portable terminal according to an exemplary embodiment of the present invention.

In an exemplary embodiment, security operations include a security operation associated with a matching between a password of the portable terminal and a password of a security card in near communication with the portable terminal, a security operation associated with a matching of a predetermined touch pattern which is predefined in the security card, and a security operation associated with a matching of movement/operation of the portable terminal which is predefined in the security card. Although it is illustrated that security certification processes are performed through three security operations, the type and order of the security operations for the security certification processes may be selectively predetermined by the user. Also, the predefined touch pattern and the movement/operation of the portable terminal used during the security operations may be selectively predetermined by the user.

Referring to FIGS. 2A and 2B, when certification is requested during the performance of a relevant function in the portable terminal, the control unit 110 detects the request in step 201 and determines whether security certification processes are set in the portable terminal.

When security certification processes are set in the portable terminal, the control unit 110 detects this in step 202 and controls the security certificating unit 170 to perform the security certification processes.

In step 203, the security certificating unit 170 requests first (or primary) security certification by displaying a message indicating the establishment of contact of a security card with the portable terminal. When the security card contacts or in near communication with the portable terminal, the security certificating unit 170 detects this in step 204 and receives password information stored in the security card through the wireless communication between the NFC unit 180 of the portable terminal and an NFC unit of the security card.

FIG. 3A illustrates a security card having an NFC unit in near communication with the portable terminal for the first security certification.

When the password information received from the security card is identical to password information stored in the portable terminal, the security certificating unit 170 detects this in step 205 and completes the first security certification in step 206.

In step 207, the security certificating unit 170 requests the second (or secondary) security certification to request the input of a predetermined touch pattern with the security card in contact with the portable terminal.

As illustrated in FIG. 3B, the display unit 160 of the portable terminal may display a plurality of region for touch pattern input.

Thus, when some of the regions are touched in a predetermined order as predefined in the security card, the security certificating unit 170 detects the matching of the inputted touch pattern in step 208 and completes the second security certification in step 211.

However, when the inputted touch pattern is not identical to the predefined pattern in the security card less than a predetermined number of times (e.g., three times), the security certificating unit 170 detects this through steps 208 and 209 and returns to step 208. When the inputted touch pattern is not identical more than a predetermined number of times (e.g., three times), the security certificating unit 170 detects this through steps 208 to 210 and returns to step 204.

In step 212, the security certificating unit 170 requests the third security certification to request to perform a predetermined movement/operation of the portable terminal.

When the portable terminal performs a predetermined movement/operation such as an operation of moving in a vertical orientation once and then moving in a horizontal orientation once as illustrated in FIG. 3C, the sensor unit 190 detects these motion pattern and transmits a detection signal to the security certificating unit 170. According to the detection signal received from the sensor unit 190, the security certificating unit 170 detects the matching of the portable terminal's movement/operation in step 213 with a preset movement/operation pattern in the security card and completes the third security certification in step 216.

However, when the portable terminal's operation is not identical less than a predetermined number of times (e.g., three times), the security certificating unit 170 detects this through steps 213 and 214 and returns to step 213. When the portable terminal's operation is not identical more than a predetermined number of times (e.g., three times), the security certificating unit 170 detects this through steps 213 to 215 and returns to step 204.

When the security certificating unit 170 notifies the completion of all the certification processes to the control unit 110 after completion of the third security certification in step 216, the control unit 110 performs a relevant function in step 217.

As described above, the present invention provides a multiple security certification apparatus and method in a portable terminal, thereby making it possible to enhance security in the portable terminal.

The above-described methods according to the present invention can be realized in hardware or as software or computer code that can be stored in a recording medium such as a CD ROM, an RAM, a floppy disk, a hard disk, or a magneto-optical disk or downloaded over a network, so that the methods described herein can be executed by such software using a controller that may be a general purpose computer, a special processor, a programmable or dedicated hardware, such as an ASIC or FPGA. As would be understood in the art, the computer, the processor or the programmable hardware include memory components, e.g., RAM, ROM, Flash, etc. that may store or receive software or computer code that when accessed and executed by the computer, processor or hardware implement the processing methods described herein. As would be recognized by those skilled in the art, when a general purpose computer is loaded with, or accesses, software or code for implementing the processing shown herein, the general purpose computer is transformed into a special purpose computer that may at least perform the processing shown herein.

While the invention has been shown and described with reference to exemplary embodiments thereof, it will be understood by those skilled in the art that various changes in form and details may be made therein without departing from the spirit and scope of the invention as defined by the appended claims. Therefore, the scope of the invention is defined not by the detailed description of the invention but by the appended claims, and all differences within the scope will be construed as being included in the present invention.

What is claimed is:

1. An apparatus for certificating security in a portable terminal, comprising:
a security certificating unit for performing a plurality of security certification processes through a plurality of security operations performed in the portable terminal; and
a control unit for performing a relevant function after a completion of the plurality of security certification processes through the plurality of security operations in sequence.

2. The apparatus of claim 1, wherein the security operations include one of: a first security operation associated with a matching between a password of the portable terminal and a password of a security card in near communication with the portable terminal, a second security operation associated with a matching of a touch pattern input in the portable terminal and a predetermined touch pattern stored in the security card, a third security operation associated with a matching of a movement/operation of the portable terminal with a predefined movement/operation pattern stored in the security card, and a fourth security operation associated with a frequency and a set period of near communication of the security card with the portable terminal.

3. The apparatus of claim 1, wherein the security certificating unit performs the plurality of security certification processes while performing the plurality of security operations in a predetermined order.

4. The apparatus of claim 1, wherein the order of the plurality of security operations for the plurality of security certification processes is selectively provided by a user.

5. The apparatus of claim 1, wherein the security certificating unit performs an initial security operation if a specific security operation does not match more than a predetermined number of times while the security certification processes are performed through the security operations in a predetermined order.

6. The apparatus of claim 2, wherein the third security operation associated with the matching of the movement/operation of the portable terminal comprises motioning of the portable terminal in a vertical orientation and in a horizontal orientation.

7. A method for certificating security in a portable terminal, comprising:
determining whether a plurality of operations performed in the portable terminal is identical to a plurality of security operations; and
completing a plurality of security certification processes and performing a relevant function when the plurality of operations performed in the portable terminal in sequence are identical to the plurality of security operations.

8. The method of claim 7, wherein the security operations include one of:
a first security operation associated with a matching between a password of the portable terminal and a password of a security card in near communication with the portable terminal, a second security operation associated with a matching of a touch pattern input in the portable terminal and a predetermined touch pattern stored in the security card, a third security operation associated with a matching of a movement/operation of the portable terminal with a predefined movement/operation pattern stored in the security card, and a fourth security operation associated with the a frequency and a set period of near communication of the security card with the portable terminal.

9. The method of claim 7, wherein the plurality of security certification processes are performed while the plurality of security operations are performed in a predetermined order.

10. The method of claim 7, wherein the order of the plurality of security operations for the security certification processes is selectively provided by a user.

11. The method of claim 7, further comprising performing an initial security operation if the security operation is not identical more than a predetermined number of times while the security certification processes are performed through the security operations in the predetermined order.

12. The method of claim 7, wherein the determining of whether the plurality of operations performed in the portable terminal is identical to the plurality of security operations comprises:
performing a first certification process of determining whether a password of a security card in near communication with the portable terminal is identical to a password of the portable terminal;
performing, upon completion of the first certification process, a second certification process of determining whether a touch pattern input on the portable terminal is identical to a predetermined touch pattern stored in the security card;
performing, upon completion of the second certification process, a third certification process of determining whether a movement/operation of the portable terminal is identical to a predetermined operation pattern of the portable terminal stored in the security card; and
performing, upon completion of the third certification process, a fourth certification process of determining whether a frequency and a set period of contact of the security card with the portable terminal is identical to a predetermined frequency and period.

13. The method of claim 12, further comprising performing the security certification processes sequentially from the first certification process if the security operation in the certification process is not identical more than a predetermined number of times while the first to fourth certification processes are performed sequentially.

14. A portable terminal for certificating security when in near communication with a security card, comprising:
a security certificating unit for performing a plurality of security certification processes through a plurality of security operations performed in the portable terminal, the plurality of security operation includes a first security operation of matching between a password of the portable terminal and a password of the security card, a second security operation of matching between a touch pattern input in the portable terminal and a predetermined touch pattern stored in the security card, a third security operation of matching between a movement/operation of the portable terminal and a predefined movement/operation pattern stored in the security card; and
a control unit for performing a relevant function after a completion of the plurality of security certification processes through the plurality of security operations.

15. The terminal of claim 14, wherein the security certificating unit further performs a fourth security operation associated with a frequency and a set period of near communication of the security card with the portable terminal.

16. The terminal of claim 14, wherein the security certificating unit performs the plurality of security certification processes while performing the plurality of security operations in a predetermined order.

17. The terminal of claim 14, wherein the order of the plurality of security operations for the plurality of security certification processes is selectively provided by a user.

18. The terminal of claim 14, wherein the security certificating unit performs an initial security operation if a specific security operation does not match more than a predetermined number of times while the security certification processes are performed through the security operations in a predetermined order.

19. The terminal of claim 14, wherein the third security operation of matching between the movement/operation of the portable terminal comprises motioning of the portable terminal in a vertical orientation and in a horizontal orientation.

20. The method of claim 12, wherein the third security operation comprises motioning of the portable terminal in a vertical orientation and in a horizontal orientation.
